(19) United States
(12) Patent Application Publication
(10) Pub. No.: US 2007/0203907 A1
(43) Pub. Date: Aug. 30, 2007

(54) User interface for entry of step changes

(75) Inventor: Chung-Suk Charles Lee, Durham, NC (US)

Correspondence Address: THE ECLIPSE GROUP, 10605 BALBOA BLVD., SUITE 300, GRANADA HILLS, CA, 91344, US

(73) Assignee: Polyglot Systems, Inc., Morrisville, NC (US)

(21) Appl. No.: 11/701,575

(22) Filed: Feb. 2, 2007

Related U.S. Application Data
(60) Provisional application No. 60/764,974, filed on Feb. 3, 2006.

(51) Int. Cl. G06F 17/30

(52) U.S. Cl. 707/6

(57) ABSTRACT

A user interface for capturing user input for a non-uniform pattern of N quantities associated with a set of N time periods. The user interface allows the capture of the N quantities without the need to input N separate values. One implementation allows the user to input a sequence of step changes. Other implementations allow the user to select a pattern and provide a few parameters so that a non-uniform pattern of step changes is created by the system. Some implementations may allow subsequent adjustment of the created pattern. One use of this user interface is to capture medication instructions to either ramp up the dose of a medication or to taper down a dose of medication. These instructions may be communicated electronically to other systems, stored, or printed. This abstract is provided as an aid in locating patents of relevance to a particular topic and not as an outer bound on the scope of the claims.

This application claims priority to and incorporates by reference herein, U.S. Provisional Patent Application No. 60/764,974 filed Feb. 3, 2006.

This invention was made with government support under grant number 1 R43 MD001212-01 awarded by the National Institute of Health (“NIH”). The United States Government has certain rights in the invention

### BACKGROUND OF THE INVENTION

1. Field of the Invention

This invention relates generally to information systems and more particularly to user interfaces to provide data input.

2. Problem Addressed

In a range of situations, it is necessary for a user to input a series of quantities associated with a series of time periods. Often the quantity associated with one time period is the same quantity associated with the next several time periods. After a number of time periods, a new quantity may be associated with one or more time periods. For example when prescribing medication, it may be appropriate to progress through several iterations of increasing dosages (or decreasing doses). So the first 5 days may be at ½ a tablet. The next five days may be at one full tablet. The following ten days may be at 1½ tablet. Finally, the patient is at a dose of 2 full tablets a day. As the dosage is not uniform for the entire month, it is tedious to provide this information to a program handling medical information such as a program to write prescriptions or to provide patient instructions for prescriptions. While it may not seem to be a tremendous problem to enter in a input screen the regime for the month 0.5, 0.5, 0.5, 0.5, 0.5, 1, 1, 1, 1, 1, 1.5, 1.5, 1.5, 1.5, 1.5, 2, 2, 2, 2, 2, 2, 2, 2, 2, 2, 2, 2, 2, 2, and 2 next to the appropriate days of the month on an input screen, this form of input is tedious and particularly so if this type of input is required many times a day such as in a pharmacy that needs to convert prescriptions to written directions for patients.

A better user interface is needed in order to quickly enter this type of information in an intuitive manner.

### SUMMARY

Disclosed below is a user interface for capturing user input for a non-uniform pattern of N quantities associated with a set of N time periods. The user interface allows the capture of the N quantities without the need to input N separate values. One implementation allows the user to input a sequence of step changes. Other implementations allow the user to select a pattern and provide a few parameters so that a non-uniform pattern of step changes is created by the system. Some implementations may allow subsequent adjustment of the created pattern. One use of this user interface is to capture medication instructions to either ramp up the dose of a medication or to taper down a dose of medication. These instructions may be communicated electronically to other systems, stored, or printed.

### BRIEF DESCRIPTION OF THE FIGURES

FIG. 1 is a representation of a computer system such as personal computers known in the art.

FIG. 2 is a representation of an input screen to receive a non-uniform pattern of quantities associated with a series of time periods (in this case days).

FIG. 3 shows the input screen from FIG. 2 with a first drop-down window open and a range of dosage levels is provided from 1 to 10 units a day.

FIG. 4 shows the result in one implementation after selecting 6 units per dose in FIG. 3.

FIG. 5 shows the input screen of FIG. 4 with a drop-down menu open for day 5.

FIG. 6 shows the input screen after step change inputs have been provided at day 1, day 5, day 8, day 11, day 14, day 17 and down to “stop” at day 20.

FIG. 7 shows a translation of the inputs as provided to the person receiving the instructions of the medication.

FIG. 8 shows the four inputs that a user would provide to obtain a pattern of doses.

FIG. 9 shows the pattern of doses from the inputs provided in FIG. 8.

FIG. 10 shows the result of making changes to specific doses to the pattern provided in FIG. 9.

### DETAILED DESCRIPTION

The present invention will now be described more fully hereinafter with reference to the accompanying drawings, in which examples of the invention are shown for the sole purpose of conveying the concepts of this invention to those of skill in the art. The actual scope of the invention is not limited by the precise examples used to teach the concepts but by the scope of the claims granted in connection with this application.

The present invention can be used as part of a user interface that can be incorporated in computer software running on a computer. The software must be stored on media and be accessible by a processor which executes the program. The program must be able to receive input from the user. The program must be able to act through the computer system to communicate to the user and to others receiving the input from the user.

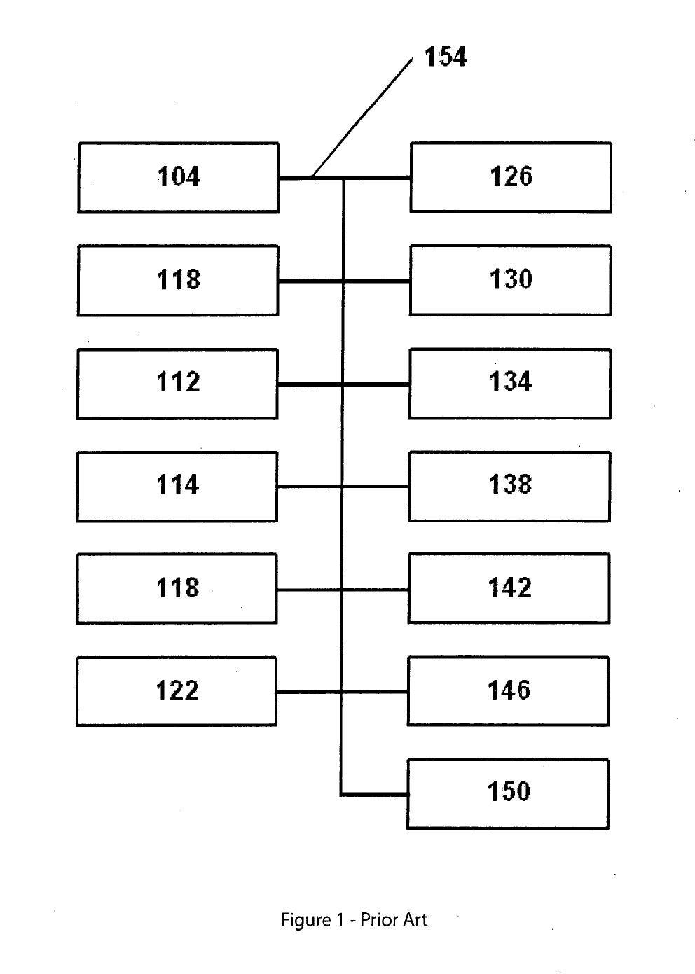

Computer systems such as personal computers are known in the art can be represented generically by FIG. 1. Such a system will comprise a number of separate pieces but can be diagrammed as follows:

Element 104 is an I/O Controller. An Input Output Controller works with the CPU for handling certain aspects of interactions with input/output devices.

Element 108 is a DMA controller to allow direct communication between certain peripherals and RAM.

Element 112 is the Central Processor Unit (CPU or Microprocessor). The CPU executes instructions and manipulates data.

Element 114 is the Clock. The clock provides the one or more clock signals used by other components.

Element 118 is the RAM (Random Access Memory) which is used for temporary memory when executing software.

Element 122 is the ROM (Read Only Memory) which contains permanent memory such as start up instructions for the CPU.

Element 126 is a Mass Storage Device. Most computers have one or more mass storage devices such as hard drives that store programs and data.

Element 130 is a Media Drive. Most computers have one or more media drives such as CD drives or disc drives which can read programs and data from removable media. Many of these drives can also write to removable media.

Element 134 is a Display. Most computers have one or more displays for displaying text or graphics.

Element 138 is an Input Device. Most computers have one or more input devices such as keyboards, computer mouse, touch pad, touch screen, light pen, digitizer tablet, or joy stick. Most computers have more than one input device such as a keyboard and a mouse.

Element 142 is a Network Connection. Many computers have one or more network connections. The network connection may include a specialized card such as a NIC card (network interface card), or a wireless card to enable a particular type of wireless connection such as Bluetooth or one of the versions of 802.11.

Element 146 is a Printer. Most computers have some access to a printer or other output device that produces output on paper. These include printers, plotters, bar code printers. Some computers access printers through the network connection.

Element 150 is a Speaker. Most computers have one or more speakers to provide audio feedback, music, sound effects, and voice.

Element 154 represents the buses. The various components in the computer are connected by a set of buses that carry data, control signals, and addresses. As the subject matter of this patent does not involve an improvement to computer buses, the buses are shown in an over simplified manner to avoid unnecessary clutter.

Those of ordinary skill in the art will recognize that FIG. 1 does not capture all of the subcomponents necessary to operate a computer (no power supply for example). FIG. 1 does not show all possible variations of computers as certain elements can be combined together such as combining the clock and the CPU. Further, a computer may have more elements than are shown in FIG. 1 including multiple instances of components shown in FIG. 1 and additional elements not shown in FIG. 1. Finally a computer can be configured to be lacking one or more elements shown in FIG. 1. For example a computer can be configured to operate without a DMA controller, or some elements of the computer of FIG. 1 can be removed from the computer, especially if it has access to such components through a network connection.

While the use of the term computer is useful for providing background information and context, it is not intended to be limiting. The present invention could be incorporated on a related device such as a Personal Digital Assistant (PDA) or any other device capable of receiving input and using that input in connection with the execution of other instructions. It does not matter for purposes of the present invention whether the instructions used to operate the device are contained in software, firmware, or hardware.

Those of skill in the art understand that a common use of a tablet computer is to display certain indicators such as buttons or items for selection and to provide input zones behind these displayed objects so that the movement of the stylus (or finger on a touch screen) to make contact or come in close proximity to the displayed button provides an input that has been programmed to correspond to the particular displayed indicator. This same sort of input process is common in non-tablet computers as a mouse or other x-y input device is used to open drop down menus and select one of the possible choices. Again there is a difference between the displayed information and the actual input process which associates an input with a particular portion of the display screen such that the input is interpreted by the program to be a selection of a particular input. In order to avoid repeating this concept throughout this application, the displayed item will be treated as an input selection choice without making the displayed image/zone of input distinction.

Those of skill in the art recognize that a scheme that relies on x-y input to open menus and make choices could be adapted for use with a keyboard without an x-y input device. The tools available include use of tab key to move from field to field, or use of characters, perhaps in conjunction with special keys such at the ALT key to select menus or choices within the menu. The direct entry of values is also possible with a keyboard such as indicating that 2 pills need to be taken. Adaptation of the example provided in this application to use on a keyboard driven application does not change the nature of the invention and such applications are intended to be covered by the claims arising from this application unless specifically disclaimed.

### First Example to Illustrate the Invention

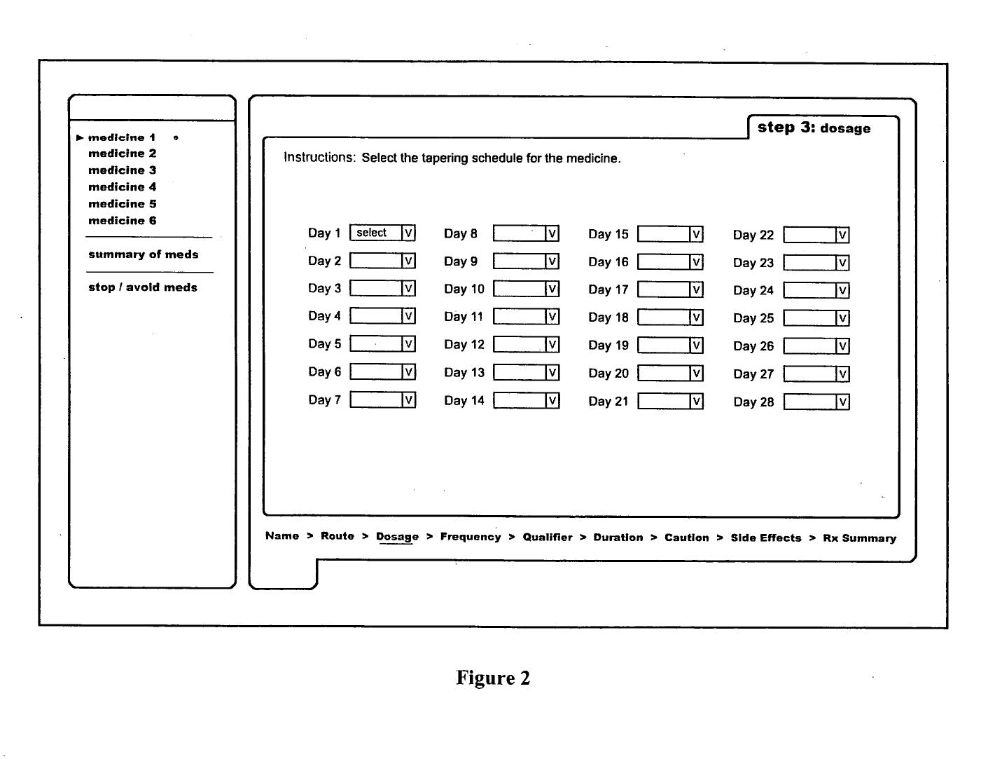

Turning to FIG. 2, an input screen is presented that is part of a larger system to collect information about medications to be provided to a patient. This invention can be incorporated as an extension of the novel system described in co-pending and commonly assigned U.S. patent application Ser. No. 11/305,519 for Methods and Systems for Conveying Instructions for Medications. The disclosure is incorporated by reference in its entirety and the reader is encouraged to read this disclosure. The '519 application is directed to a system for conveying information about medication to a person who is not fluent in the language of the person providing the instructions. The present invention can be used in other contexts and is not limited to that particular application.

FIG. 2 shows a screen that is particularly useful when the dosage for a particular medication will vary over the relevant period of the prescription. FIG. 2 has a matrix of 28 input windows, each with a drop down menu. The 28 input windows are linked to the 28 days of the prescription period. Twenty eight days represents a four week period which is sufficient for many ramp up or taper down routines. Once the dose has been ramped up, the dose will remain stable for a period of time and prescriptions will typically be refilled monthly.

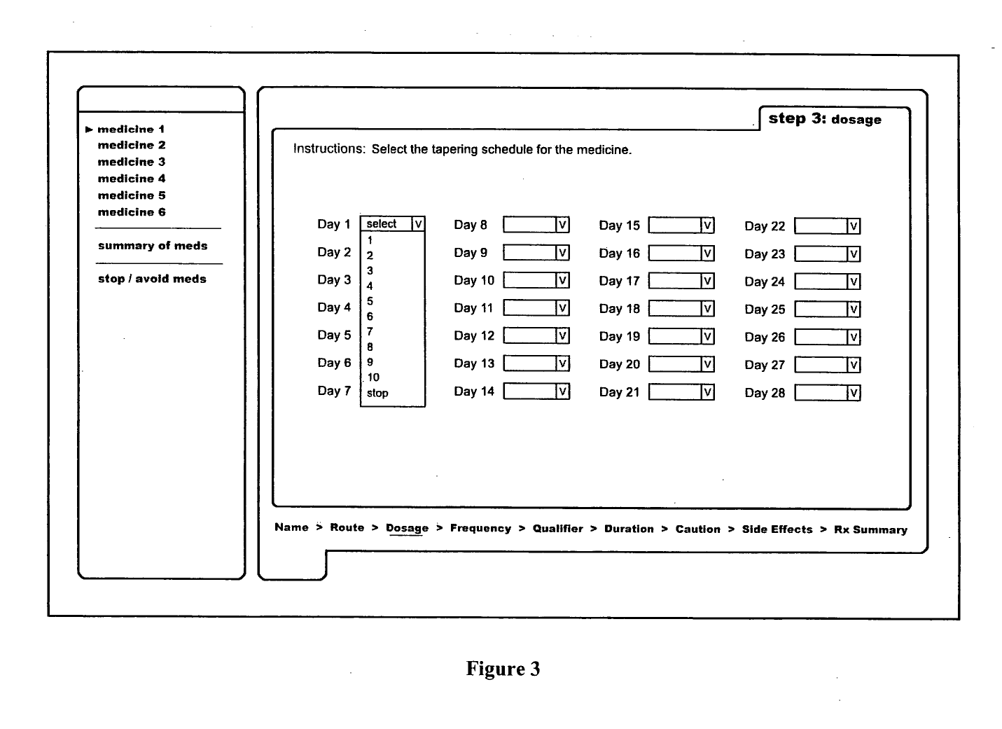

In FIG. 3, the first drop-down window has been opened and a range of dosage levels is provided from 1 to 10 units a day. Another choice that would be relevant for subsequent days is to stop taking the prescription. If the process which led to this screen indicated that the screen was to be used for ramping up a medication rather than tapering down, the option of stop would not need to be offered. However, this screen could be used for both ramp up and taper down instructions as the user would not select stop as an option when capturing instructions for a ramp up of a medication.

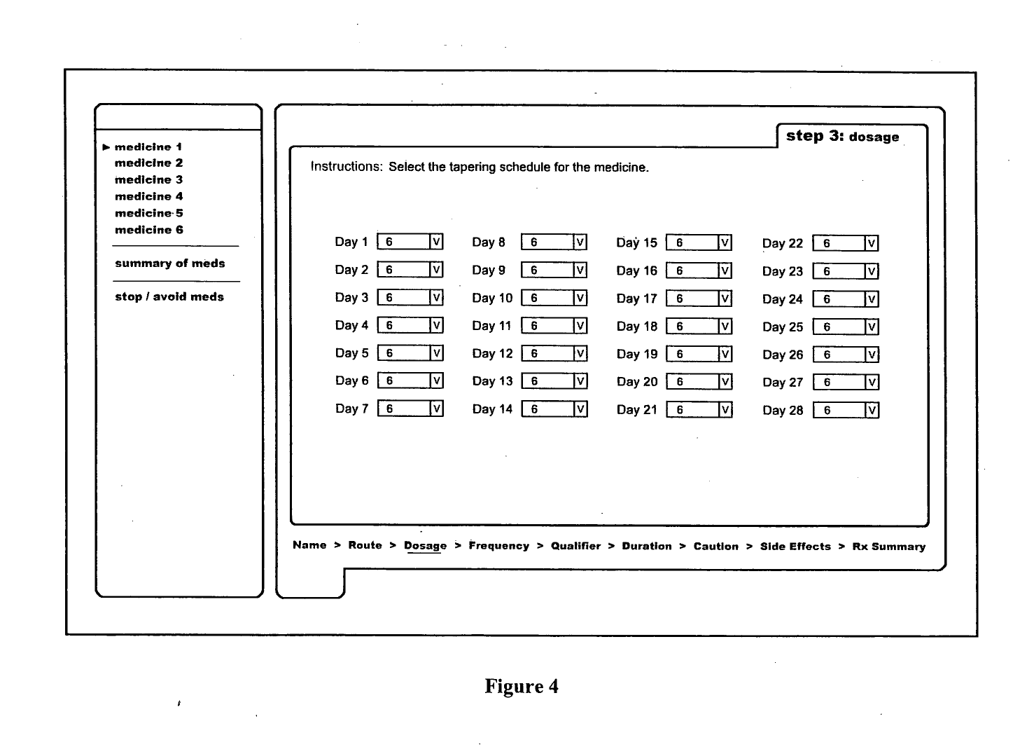

FIG. 4 shows the result after selecting 6 units per dose in FIG. 3. The program assumes that the units per dose will remain at 6 unless additional input is provided to indicate a step change in the units per dose.

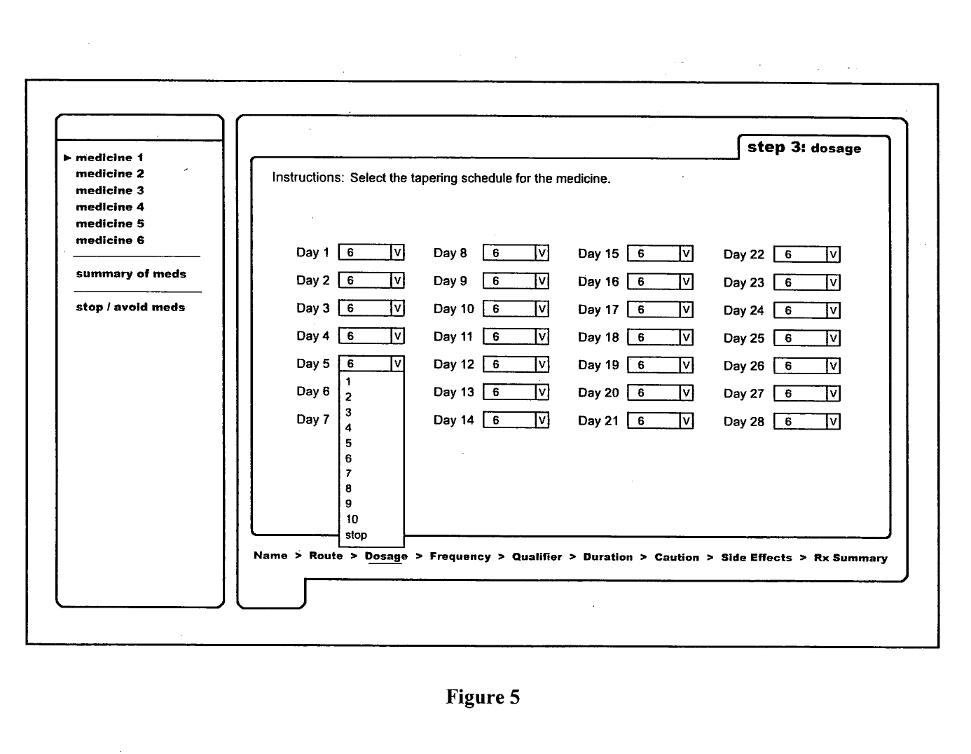

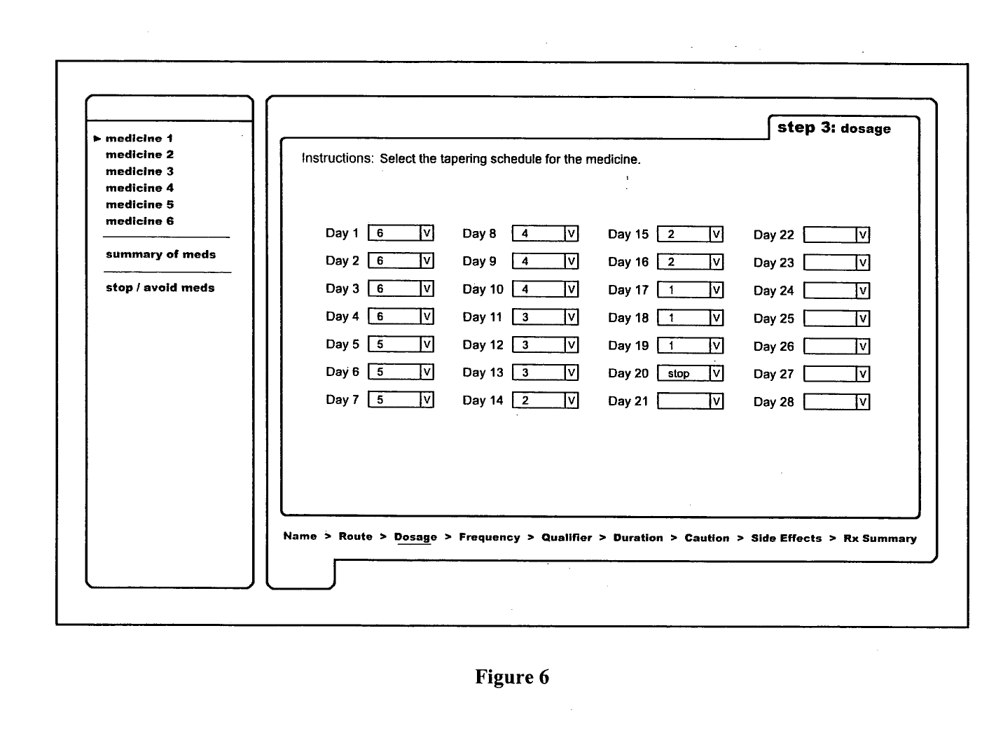

FIG. 5 shows a drop-down menu open for day 5. FIG. 6 shows the input screen after step change inputs have been provided at day 1, day 5, day 8, day 11, day 14, day 17 and down to “stop” at day 20. A relatively complex tapering scheme has been input in an intuitive way with relatively few inputs and is displayed for the user to review and approve before proceeding. Any addition or alteration of a step change would tell the system to change all subsequent days until the next entered step change.

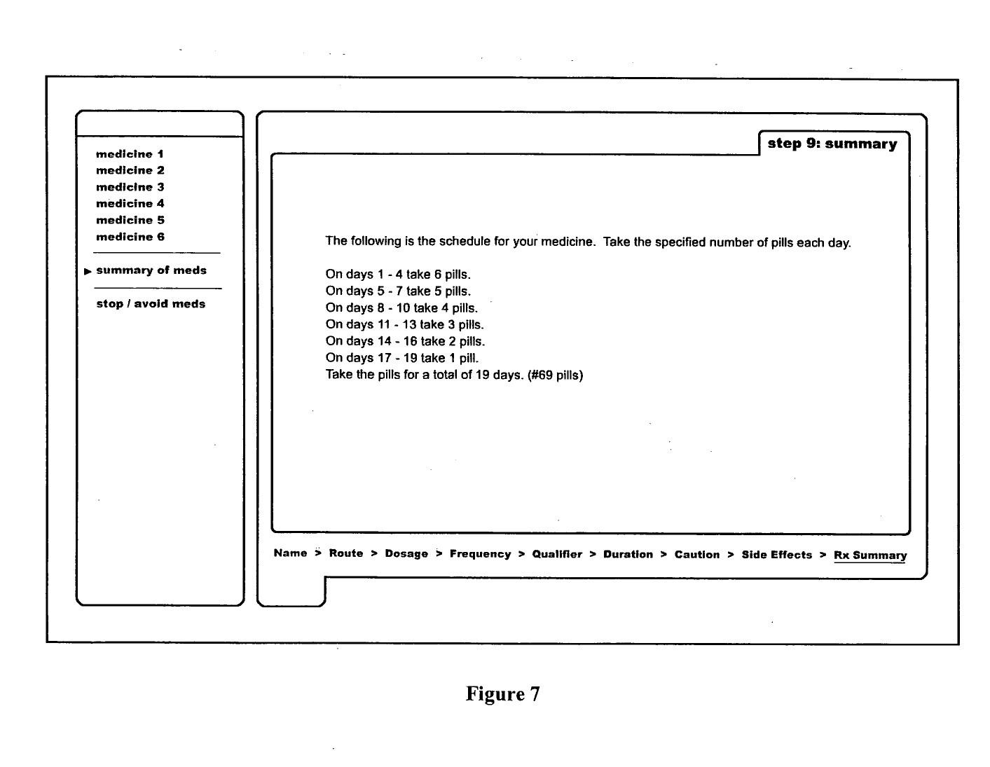

FIG. 7 shows a translation of the inputs as provided to the person receiving the instructions of the medication. Here the input shown in FIG. 5 is provided as text and includes a total number of pills to be taken. The pattern may be communicated electronically to another computer system or to storage, for example, to the records associated with this patient. The pattern may be communicated by printing so that a printed copy may be provided to the person receiving the medication. The pattern may be printed to be added to the medical records for the patient.

The example given shows a downward taper of the number of pills provided. One of skill in the art will recognize that the same input screens could be used to provide an upward ramp of medication.

The example given shows the dose given at a given time and based on the total count of pills, the frequency of administration is once per day. The invention is not limited to use for medications administered once per day. If the instruction was to take the medication twice per day, then the same dosage taper would apply but the patient would be instructed to take half the medicine in the morning and half in the evening.

The example given uses integral numbers for the dosage. Some tablets are scored to allow them to reliably be broken into two parts (some are adapted for more than two parts). When working with tablets of this type, the drop down menu could include non-integer choices such as 1.5 pills. The user could get to this input screen by either opting for an input screen with partial pill choices or by the system knowing the medication being prescribed and offering partial pill choices as that is a common option for that particular medication.

In a like manner, medications placed into liquid form and administered orally, are often provided in teaspoons or partial teaspoons. Alternatively, the medication may be dosed in cubic centimeters on a syringe used for delivering medication to the mouth of a patient. Appropriate drop down screens for this type of dosing can be reached by either the user navigating to the appropriate input screen, by the system presenting a particular type of input choices based on the medication being prescribed or by a combination of both.

In the example provided above, the unit of time is the day. This inventive concept could be used for medications that are provided many times a day (such as every four hours). If it is useful to change the dosage used more frequently than once a day, the input screen could provide the inputs every four hours and the same process of designating only the step-changes in dosage could be used.

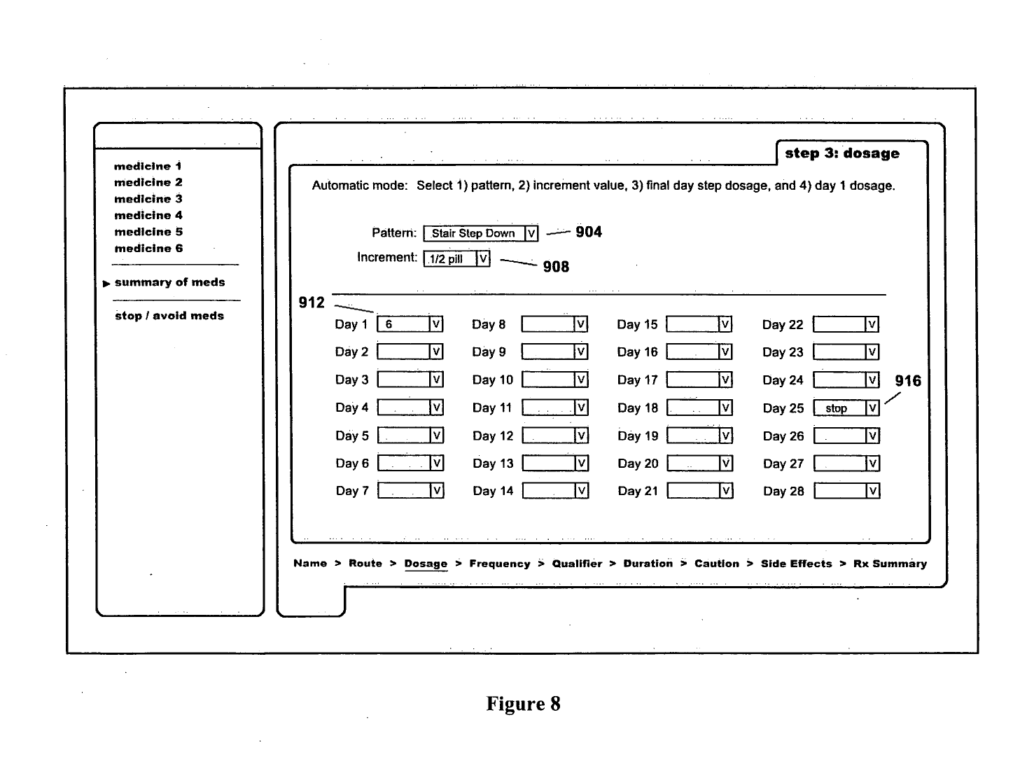

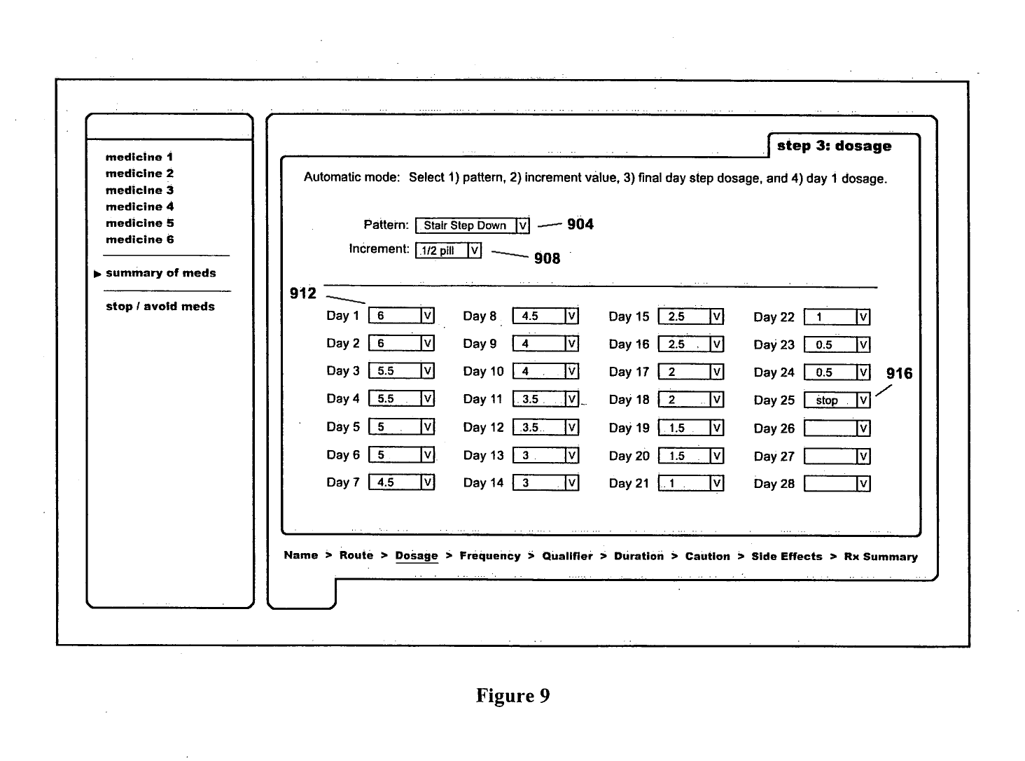

The present invention can include assisting the user in creating the pattern of increasing or decreasing amounts in accordance with a set pattern. For example in FIG. 8 if the user provides four inputs (904, 908, 912, and 916) that is sufficient to input the 24 doses shown in FIG. 9 and stopping on day 25 as the user interface will work with those four inputs to create a proposed dose pattern. More specifically, input 904 is the taper pattern in this case a stair step down pattern. Input 908 is the step increment to be used. The increment here is a half pill, but it could be a whole capsule, a number of cubic centimeters or some other increment. Input 916 is the final day of the step dosage. In this case “stop” or 0 on day 25. Input 912 is the start dose starting at 6 pills per time unit, with an increment size of ½ pill. After entering these four attributes, the system could populate the days 2 to 24 with a proposed dosage. FIG. 9 shows the results of the proposed dosages.

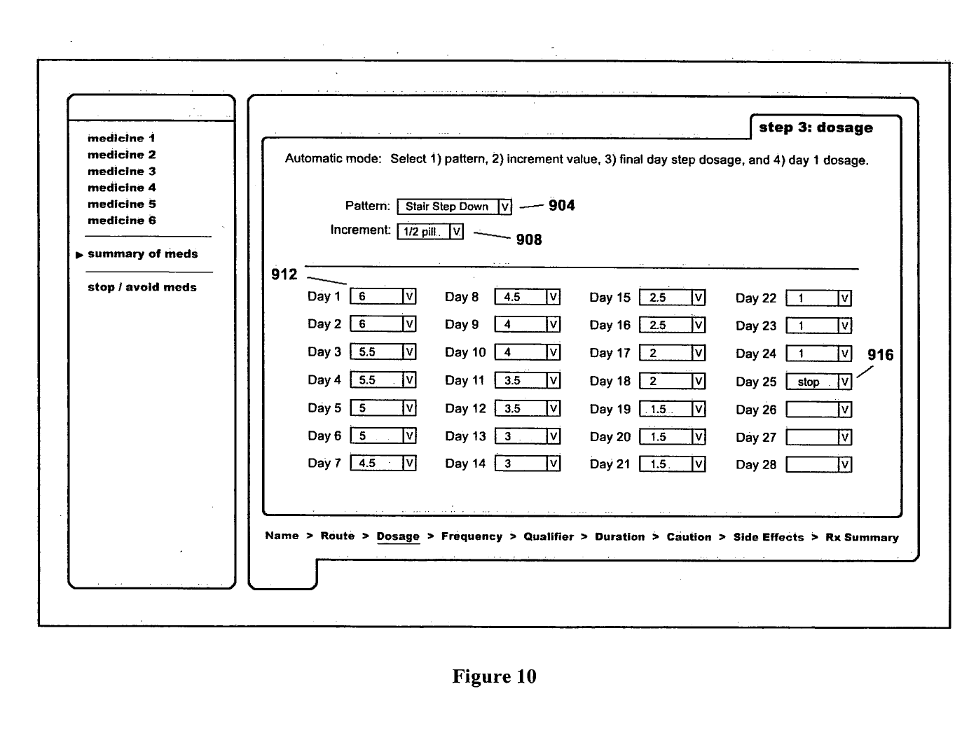

If the user wishes to modify the proposed doses for any reason, the user can adjust individual days up or down. In this case the user believes that one pill is the minimum dosage that will be therapeutically significant so the user changes the taper to change the dose from day 21 from one pill to 1.5, changes the dose on day 23 to one pill, and changes the dose on day 24 to one pill. FIG. 10 shows the result after making those three changes. A variation on this feature is to not allow for alteration of the doses generated by the system. The use of a pattern to generate proposed doses works as well on the way up where you would have three inputs, pattern, increment, and the amount of the maintain dose entered into the first day to receive the maintain dose. If other patterns are useful for a particular class of medication, those patterns could be provided as options to be selected. It is possible that some patterns may need one or more additional inputs.

The examples provided above were for medication doses. There are other situations where step changes for a variable need to be input. For example in various financial models it may be useful to provide: A) the amount of money to be added to an account per month (such as an account for saving for Christmas presents); or B) the amount of money saved per year such as for college or retirement savings when it is known that the amount saved per year will receive a step increase after the end of some other expense. For people creating a number of models per day or perhaps manipulating the same model with different input patterns, it may be useful to have an efficient user interface to capture step changes in a variable just as it is for those recording instructions with respect to medications. In areas outside of medication dosing, there may be a broader range of patterns that are useful for generating an initial set of amounts. For example, a sinusoidal pattern could be selected and then provided with an amount in a time period that represents a sinusoidal apex and the amount representing the nadir value placed in an adjacent nadir time period, the end period for calculating values, and, if desired, the minimum increment for change. One of skill in the art will recognize that alternative embodiments set forth above are not universally mutually exclusive and that in some cases alternative embodiments can be created that implement two or more of the variations described above.

It will be understood, and is appreciated by persons skilled in the art, that one or more processes, sub-processes, or process steps described above may be performed by hardware, firmware, and/or software. If the process is performed by software, the software may reside in software memory in a suitable electronic processing component or system. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable (or signal-bearing) medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” and/or “signal-bearing medium” is any means that may contain, store, communicate, propagate, or transport the program for use by or in connection with the instruction execution system, apparatus, or device. The computer-readable medium may selectively be, for example, but is not limited to, an electronic, magnetic, optical, electromagnetic, infrared, or semiconductor system, apparatus, device, or propagation medium. More specific examples, but nonetheless a non-exhaustive list, of computer-readable media would include the following: an electrical connection having one or more wires, a portable computer diskette, a random-access memory (RAM), a read-only memory (ROM), an erasable programmable read-only memory (EPROM or Flash memory), an optical fiber, and a portable compact-disc read-only memory (CD-ROM). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Those skilled in the art will recognize that the methods and apparatus of the present invention have many applications and that the present invention is not limited to the specific examples given to promote understanding of the present invention. Moreover, the scope of the present invention covers the range of variations, modifications, and substitutes for the system components described herein, as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

What is claimed is:

1. A method of producing a non-uniform pattern of N quantities associated with a set of N time periods and communicating the set of N quantities associated with the N time periods, the method comprising:
receiving a first value for a quantity associated with a first time period;
receiving a second value for a quantity associated with a second time period, the second value not equal to the first value and the second time period different than the first time period; and
associating a third quantity with a third time period without receiving a third value for the quantity to be associated with the third time period such that the pattern of N quantities associated with the set of N time periods is communicated without receiving a set of N separate input values with N quantities for the set of N time periods.

2. The method of claim 1 wherein the duration of the first time period equals the duration of the second time period but the second time period is subsequent to the first time period.

3. The method of claim 1 wherein the second time period is before a Nth time period and the method includes receiving an Nth value associated with the Nth time period.

4. The method of claim 1 wherein the Nth value is none.

5. The method of claim 1 wherein the quantities associated for each time period between an earlier time period that received a value for the quantity associated with that earlier time period and a later time period that received a value for the quantity associated with the later time period is set to be the value for the quantity associated with the earlier time value.

6. The method of claim 1 wherein the quantity associated with a time period between an earlier time period that received a value for the quantity to be associated with that earlier time period and a later time period that received a value for the quantity to be associated with that later time period is set to be a quantity between the value for the earlier time period and the value for the later time period.

7. The method of claim 1 wherein the non-uniform pattern of N quantities associated with N time periods is a set of N medication doses for a set of N time periods.

8. The method of claim 7 wherein the time periods are days.

9. The method of claim 7 wherein the time periods have durations that are less than 24 hours.

10. The method of claim 1 wherein the quantities correspond to number of pills.

11. The method of claim 10 wherein the quantities include a portion of a pill for a pill that may be broken.

12. The method of claim 1 wherein the quantities correspond to quantities of a liquid.

13. The method of claim 1 wherein the non-uniform pattern of N quantities associated with the set of N time periods is displayed and may be altered by adjusting any individual value associated with a particular time period.

14. The method of claim 1 wherein the method includes receiving a pattern type.

15. The method of claim 1 wherein the steps of receiving a first value for a quantity associated with a first time period; and
receiving a second value for a quantity associated with a second time period, the second value not equal to the first value and the second time period different than the first time period is accomplished by receiving a first value for a quantity associated with the first time period, a final value and information sufficient to determine the earliest time period associated with a quantity equal to the final value.

16. The method of claim 15 wherein the received information includes a minimum change increment to be used to calculate changes in quantities for time periods between the first time period and the earliest time period associated with the quantity equal to the final value.

17. The method of claim 1 wherein the non-uniform pattern of N quantities associated with the set of N time periods is communicated electronically to storage associated with a patient to receive medication doses according to the non-uniform pattern.

18. The method of claim 1 wherein the non-uniform pattern of N quantities associated with the set of N time periods is communicated by printing.

19. A computer system comprising:
at least one input means for receiving input from an end user;
at least one output device for communicating a non-uniform pattern of N quantities for a set of N time periods;
the computer system having access to a set of computer instructions for producing a non-uniform pattern of N quantities associated with a set of N time periods and communicating the non-uniform pattern of N quantities associated with the set of N time periods,
the instructions adapted for:
receiving a first value for a quantity associated with a first time period;
receiving a second value for a quantity associated with a second time period, the second value not equal to the first value and the second time period different than the first time period; and
associating a third quantity for a third time period without receiving a third value for a quantity for the third time period such that the non-uniform pattern of N quantities for the set of N time periods may be communicated without receiving a set of N separate input values for the N quantities for the set of N time periods.

20. The computer system of claim 19 wherein at least one output device for communicating the non-uniform pattern of N quantities for the set of N time periods includes a printer.

21. The computer system of claim 19 wherein at least one output device for communicating the non-uniform pattern of N quantities for a set of N time periods includes a communication device for conveying an electronic representation of the non-uniform pattern of N quantities for the set of N time periods.

22. Machine readable media containing software for producing a non-uniform pattern of N quantities associated with a set of N time periods and communicating the set of N quantities associated with the set of N time periods,
the software adapted for:
receiving a first value associated with a quantity for a first time period;
receiving a second value associated with quantity for a second time period, the second value not equal to the first value and the second time period different than the first time period; and
associating a third quantity with a third time period without receiving a third value for a quantity for the third time period such that the non-uniform pattern of N quantities for the set of N time periods may be communicated without receiving a set of N separate input values for the N quantities for the set of N time periods.
